SEQUENCE LISTING (11 sequences)

SEQ ID NO: 1 - protein, 21 aa, Artificial Sequence
  Synthetic
MEELADSLEELARQVEELESA

SEQ ID NO: 2 - protein, 21 aa, Artificial Sequence
  Synthetic
LEELADSLEELAEQVEELLSA

SEQ ID NO: 3 - protein, 21 aa, Artificial Sequence
  Synthetic
EISALEAEISALEAEISALEA

SEQ ID NO: 4 - protein, 21 aa, Artificial Sequence
  Synthetic
AISELEAEISALEAEIESLAA

SEQ ID NO: 5 - protein, 21 aa, Artificial Sequence
  Synthetic
AIESLAESIEELAEAISELAA

SEQ ID NO: 6 - protein, 21 aa, Artificial Sequence
  Synthetic
MKQLADSLHQLARQVSRLEHA

SEQ ID NO: 7 - protein, 21 aa, Artificial Sequence
  Synthetic
MKQLADSLHQLAHKVSHLEHA

SEQ ID NO: 8 - protein, 25 aa, Artificial Sequence
  Synthetic
PLAEIDSALAEIEAQVAELIAAVED

SEQ ID NO: 9 - protein, 25 aa, Artificial Sequence
  Synthetic
PLEAIADSLEAIAEQVEALIEAVAD

SEQ ID NO: 10 - protein, 25 aa, Artificial Sequence
  Synthetic
PGIAELEAELSAVEAELEAILAELD

SEQ ID NO: 11 - protein, 21 aa, Artificial Sequence
  Synthetic
LAELESLLAELEALVAELLSA

(19) United States
(12) Patent Application Publication
(10) Pub. No.: US 2013/0035266 A1
(43) Pub. Date: Feb. 7, 2013

(54) COALESCENCE OF EMULSIONS

(71) Applicant: Annette Faith Dexter, Salisbury (AU)

(72) Inventor: Annette Faith Dexter, Salisbury (AU)

(73) Assignee: PEPFACTANTS PTY LTD, St Lucia (AU)

(21) Appl. No.: 13/636,164

(22) PCT Filed: Mar. 22, 2011
(86) PCT No.: PCT/AU2011/000320

§ 371 Date: Sep. 20, 2012

(30) Foreign Application Priority Data
Mar. 22, 2010 (AU) 2010901214

(51) Int. Cl. C09K 8/58

(52) U.S. Cl. 507/240; 507/239; 507/269; 507/244; 507/267; 507/242

(57) ABSTRACT

The invention relates to methods of controlling the stability of emulsions to coalescence and phase separation. Use of chaotropic counterions to promote coalescence and/or phase separation of emulsions stabilized by ionic surfactants is described.

### FIELD OF THE INVENTION

The present invention relates to methods of controlling the stability of emulsions to coalescence and phase separation. In particular, the invention relates to the use of chaotropic counterions to promote coalescence and/or phase separation of emulsions stabilized by ionic surfactants. Utility of the methods is also described.

### BACKGROUND OF THE INVENTION

Surface-active agents (surfactants) are chemical species that are able to adsorb at fluid-fluid interfaces to reduce the interfacial tension. They are used in the preparation of oil and water emulsions for a wide range of applications, for example oil recovery, drilling, metalworking, lubrication, catalysis, cleaning, agrichemical dispersions, drug delivery, processed foods and personal care. Surfactants may be nonionic or ionic, with ionic surfactants further subdivided into anionic, cationic and zwitterionic (amphoteric) classes. Surfactants can be used to facilitate the formation of emulsions and increase the lifetime of an emulsion once formed thereby enhancing the stability of the emulsion. However, in some cases it may be desirable to separate the oil and water phases of an emulsion after formation in a controlled manner, for example to permit recovery of a valuable oil phase, to allow separation of a clean water phase, or to facilitate recovery of a valuable component dissolved within either an oil phase or a water phase.

Emulsions are thermodynamically unstable suspensions or dispersions of one liquid in a second liquid with which it is not miscible. Commonly one of the liquids is water or an aqueous solvent, and the second, immiscible liquid is referred to as an oil. The lifetime of an emulsion is increased by mechanisms that inhibit the various known modes of emulsion instability, including flocculation, creaming, Ostwald ripening and coalescence (Binks 1998). For the purposes of this invention, the mechanism of primary importance is coalescence, the process by which two or more drops collide and join to form a single drop. A sufficient number of coalescence events will ultimately lead to the complete separation (phase separation) of the two liquid phases of an emulsion.

Emulsions prepared using ionic surfactants are known to be unstable in the presence of high concentrations of salt (Binks 1998). However, it has usually been assumed that the effects of neutral salts in general are represented by the effects of sodium chloride, and that destabilization of emulsions by salt is slow, inefficient and incomplete.

There is a need for methods of controlling when coalescence and/or phase separation occurs and the efficiency of coalescence and/or phase separation to enable recovery of the oil or water phase or a component present in the oil or water phase in a controlled and efficient, manner.

The present inventor has surprisingly found that coalescence and/or phase separation of an emulsion stabilized with an ionic surfactant can be achieved in a controlled manner by the addition of chaotropic counterions.

### SUMMARY OF THE INVENTION

In one aspect of the invention, there is provided a method of controlling coalescence and/or phase separation of an emulsion stabilized by an ionic surfactant comprising adding to the emulsion a chaotropic counterion.

In some embodiments, the ionic surfactant is anionic. In other embodiments, the ionic surfactant is cationic. In yet other embodiments, the ionic surfactant is zwitterionic. In some embodiments the chaotropic counterion has a single charge. In other embodiments, the chaotropic counterion is a polyelectrolyte. In some embodiments, the chaotropic counterion is a polymeric polyelectrolyte. In some embodiments, the concentration of the ionic surfactant is greater at the surface of the emulsion droplet than in the bulk solution. In some embodiments, controlling coalescence and/or phase separation is promoting coalescence and/or phase separation.

In some embodiments, the ionic surfactant is anionic and the chaotropic counterion is a singly-charged ion selected from guanidinium or imidazolium ions or a polyelectrolyte selected from polyguanidine, biguanide and polybiguanide ions.

In some embodiments, the ionic surfactant is cationic and the chaotropic counterion is a singly-charged counterion selected from iodide, thiocyanate, perchlorate and hydrosulfate ions or a polyelectrolyte selected from polysulfate, polysulfonate, polyphosphate and polyphosphonate ions.

### DESCRIPTION OF THE INVENTION

### Definitions

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The singular forms “a”, “an” and “the” include plural aspects unless the context clearly dictates otherwise.

As used herein, the terms “ion” and “ionic” refer to a chemical species bearing a positive and/or negative charge. Ions bearing a positive charge are referred to as cations or being cationic. Ions bearing a negative charge are referred to as anions or anionic. Ions bearing both a positive and a negative charge are referred to as zwitterions or zwitterionic or ampholytes. Ions bearing multiple charges are referred to as polyelectrolytes or polyelectrolytic.

As used herein, the term “counterion” refers to an ion bearing a charge opposite to that of an ionic moiety of interest such as an ionic surfactant. For example, a counterion to a positively charged ionic moiety will be an anion, and a counterion to a negatively charged moiety will be a cation. In some embodiments, the ionic moiety of interest is a surfactant ion, such as a cationic or anionic surfactant ion. In some embodiments, the ionic moiety of interest is an ionic group in a zwitterionic surfactant. In some embodiments, counterions may bear a single positive or negative charge. In some embodiments, counterions may be polyelectrolytes carrying multiple charges.

As used herein, the term “co-ion” refers to an ion bearing a charge of the same kind as an ionic moiety of interest such as an ionic surfactant. For example, a co-ion to a positively charged ionic moiety will be a cation, and a co-ion to a negatively charged moiety will be an anion. In some embodiments, the ionic moiety of interest is a surfactant ion, such as a cationic or anionic surfactant ion. In some embodiments, the ionic moiety of interest is an ionic group in a zwitterionic surfactant. In some embodiments, co-ions may bear a single positive or negative charge. In some embodiments, co-ions may be polyelectrolytes carrying multiple charges.

As used herein the terms “chaotrope” and “chaotropic” refer to a chemical agent, commonly an ion, which is known to destabilize protein structure, for example, by weakening or disrupting intramolecular interactions. In the present invention a chaotrope may be defined with reference to the Hofmeister series.

The Hofmeister series comprises a listing ions ordered by the magnitude of their effects on a phenomenon of interest such as the stabilization or destabilization of proteins, as deduced from the behaviour of neutral salts containing a common ion, for example sodium salts of different anions or chloride salts of different cations. In general, Hofmeister effects begin to emerge at moderate ion concentrations (e.g. 0.01-1 M), and the effects of added anions are usually greater than those of cations. Depending on the phenomenon under study, the exact sequence of ions in the list may vary, but a typical ordering is as follow's (Collins and Washabaugh 1985; Pegram and Record 2008a):

### Anionic Series

PO₄³⁻>CO₃²⁻>SO₄²⁻˜F>acetate⁻>Cl⁻>Br⁻˜NO₃⁻>I⁻>ClO₄⁻>SCN⁻>HSO₄⁻

### Cationic Series

Mg²⁺>Ca²⁺>Ba²⁺>Li⁺>Na⁺>K⁺>NH₄⁺>Me₄N⁺>imidazolium⁺>guanidinium⁺

The anionic and cationic series are herein listed in an approximate order of decreasing strength of hydration or increasing ion polarizability. Ions to the left of the anionic series stabilize proteins against unfolding and also precipitate proteins from solution, the latter phenomenon being described as “salting out” (Aroti, Leontidis et al. 2004; Zhang and Cremer 2006; Pegram and Record 2008b). These anions are described as kosmotropes or “structure makers”. Ions to the right of the anionic series promote protein unfolding and also increase protein solubility in water, the latter phenomenon being described as “salting in”. These anions are described as chaotropes or “structure breakers”. Chloride ion is taken to have a “normal” effect on protein stability and solubility, promoting neither protein unfolding nor precipitation beyond the effects expected from changes in ionic strength alone (Collins and Washabaugh 1985), and hence is described neither as a chaotrope nor a kosmotrope. For the purposes of this invention, the ions of practical interest are those on the right-hand side of chloride in the anionic series above and on the right hand side of sodium in the cationic series above, and their polyelectrolyte derivatives. These are large, poorly-hydrated ions with low charge density and high polarizability, with a strong tendency to relocate from bulk solution to a physical or molecular interface.

The classification of cations remains less clear. While sodium, like chloride, is taken to represent a “normal” position, there exist contradictory accounts in the secondary literature of which cations act to stabilize or destabilize proteins and thus should be classified as kosmotropes or chaotropes (see Cacace, Landau et al. 1997; Broering and Bommarius 2005; Nucci and Vanderkooi 2008). This confusion may result in part from the relatively small effects of most cations on protein stability (e.g. Sedlak, Stagg et al. 2008), as well as the limited range of cations used in many studies of specific cation effects. However, while the effects of mid-series cations on stability may vary from one protein to another, it is universally recognized in the literature that guanidinium ion is a protein denaturant, i.e. a chaotrope (Dempsey, Mason et al. 2007). For the purposes of this invention, ions to the right of sodium in the cationic series above are chaotropes, and ions to the left of sodium in the cationic series are kosmotropes. Under the classification adopted for this invention, kosmotropes are small or multiply-charged anions or cations possessing a high charge density and strong interactions with water, while chaotropes are large anions or cations possessing a low charge density and weak interactions with water. Kosmotropes may in some instances be defined, as ions with a positive Jones-Dole viscosity B coefficient (Collins 2004), while chaotropes may be defined in some instances as ions having a negative Jones-Dole viscosity B coefficient.

As not all ions are listed in the Hofmeister series and not all ions conform to the above definitions relating to Jones-Dole viscosity B coefficients, the kosmotropic or chaotropic nature of an ion may be determined experimentally to determine whether it is suitable for use in the present invention.

The chaotropic character of an ion may conveniently be determined by testing the effect of the ion on the stability and solubility of a test protein or peptide, whereby chaotropic ions are expected to decrease the stability and increase the solubility of the test polypeptide, while kosmotropic ions are expected to increase the stability and decrease the solubility of the test polypeptide. For chaotropic anions, the tests should be carried out using the sodium salt of the anion. For chaotropic cations, the tests should be carried out using the chloride salt of the cation. Demonstration of a decrease in the stability of a protein or peptide may be carried out by methods including, but not limited to, demonstrating a decrease in the catalytic activity of an enzyme using standard assays; demonstrating a decrease in the temperature of half-denaturation (“melting temperature”) of the test protein or peptide by differential scanning calorimetry; and/or demonstrating a decrease in the content of α-helix or β-sheet structure of the test polypeptide by circular dichroism spectroscopy, nuclear magnetic resonance spectrometry or infrared spectroscopy. Demonstration of an increase in the solubility of a protein or peptide may be carried out by methods including, but not limited to, weighing of dried soluble and insoluble fractions of the test protein or peptide and/or analysis of solutions containing chemically labelled or unlabelled test protein or peptide by ultraviolet or visible spectroscopy, fluorescence spectroscopy, nuclear magnetic resonance spectrometry, or circular dichroism spectroscopy. The test material may be any protein or peptide, the solubility and stability of which are affected by the salt of interest in the concentration range of 0.01 to 4.0 M, preferably 0.02 to 2.0 M, more preferably 0.02 to 0.5 M. The test protein or peptide should carry a net charge identical to that of the ion being tested or should carry no net charge at the pH of testing. That is, to test the chaotropic character of a cation, a test protein or peptide carrying either no net charge or a net positive charge at the pH of testing should be chosen. Similarly, to test the chaotropic character of an anion, a test polypeptide carrying either no net charge or a net negative charge at the pH of testing should be chosen. For the purposes of this specification, the anions of interest should have a chaotropic character at least as great as nitrate ion, while cations of interest should have a chaotropic character at least as great as tetramethylammonium ion. That is, the sodium salt of a chaotropic anion useful in the present invention should decrease the stability and increase the solubility of a test protein or peptide to at least the same degree as sodium nitrate. Similarly, the chloride salt of a chaotropic cation useful in the present invention should decrease the stability and increase the solubility of a test polypeptide to at least the same degree as tetramethylammonium chloride.

Examples of chaotropic ions include guanidinium, thiocyanate, perchlorate, iodide and hydrosulfate. Examples of chaotropic salts include guanidinium chloride, guanidinium thiocyanate, sodium perchlorate, sodium thiocyanate and sodium hydrogen sulfate (sodium bisulfate, sodium hydrosulfate).

As used herein, the term “kosmotrope” refers to a chemical agent, commonly an ion, that stabilizes protein structures, for example by strengthening intramolecular interactions and is further defined in relation to the Hofmeister series above. Examples of kosmotropic ions include sulfate, fluoride, magnesium and calcium. Examples of kosmotropic salts include sodium sulfate and sodium fluoride.

As used herein, the term “polarizable” or “polarizability” refers to the relative tendency of a charge distribution, for example the electron cloud of an ion, atom or molecule, to be distorted from its normal shape by an external electric field, for example a nearby ion or dipole. A high polarizability corresponds to a high capacity for distortion and a greater capacity to interact with adjacent ions or dipoles, including either permanent or induced dipoles. Polarizability is commonly reported in units of cubic Ångstroms (Å³). Some typical values of polarizability are given in Table 1.

As used herein, the term “surface charge density” refers to the total amount of charge per unit area of a chemical moiety. For a singly-charged ion, the surface charge density decreases with increasing ion radius. Surface charge density may be reported in units of coulombs per square Ångstrom (C Å⁻²). Some typical values of ion radius and surface charge density are given in Table 1. It may be readily seen that high polarizability, low surface charge density and large ion radius are positively correlated.

TABLE 1
Physical properties of selected ions (from Collins and Washabaugh 1985)

| | Crystal Ion Radius | Polarizability | Surface Charge Density |
|---|---|---|---|
| Ion | (Å) | (Å³) | (10²¹ Coulombs Å⁻²) |
| F⁻ | 1.19 | 0.64 | −8.98 |
| Cl⁻ | 1.70 | 2.96 | −4.42 |
| Br⁻ | 1.87 | 4.16 | −3.64 |
| I⁻ | 2.12 | 6.43 | −2.84 |

As used herein, the term “hydration energy” refers to the amount of energy released on addition of one mole of a solute to water to give an infinitely dilute solution. A large hydration energy corresponds to strong interactions between the solute and water. The hydration energy is generally reported as the Gibbs free energy of hydration (ΔG_{hyd}), which is strongly negative for favourable interactions between the solute and water. Other physical parameters of interest include the molar enthalpy of hydration (ΔH_{hyd}), which is also strongly negative for favourable interactions between the solute and water, and the molar entropy of hydration (ΔS_{hyd}), which is positive when ion hydration leads to a loss of order. The Gibbs free energy and enthalpy of hydration may be reported in kcal mol⁻¹ or kJ mol⁻¹. The entropy of hydration may be reported in cal mol⁻¹K⁻¹ or J mol⁻¹ K⁻¹. The relationship between the Gibbs free energy of hydration, molar enthalpy of hydration and molar entropy of hydration is given by:

ΔG_{hyd}=ΔH_{hyd}−T·ΔS_{hyd} (Equation 1),

where T is the temperature in degrees Kelvin. Values for some selected ions are given in Table 2. It may be readily seen that strongly negative Gibbs free energies of hydration occur for small and/or multiply charged ions, and that the largest contribution to the Gibbs free energy of hydration derives from the enthalpy of hydration. In addition, by comparison with Table 1, it may be seen that small ions with high charge density and low polarizability are strongly hydrated, while larger ions with low charge density and high polarizability are weakly hydrated. A large negative Gibbs free energy of hydration also correlates with a more negative molar entropy of hydration, for example because of increased ordering of water molecules involved in ion hydration.

TABLE 2
Gibbs free energies, molar enthalpies and molar entropies of hydration of
selected ions (taken from Marcus 1986; 1987; 1991)

| | | | |
|---|---|---|---|
| | ΔG_{hyd} | ΔH_{hyd} | ΔS_{hyd} |
| Ion | (kJ mol⁻¹) | (kJ mol⁻¹) | (J mol⁻¹ K⁻¹) |

| | | | |
|---|---|---|---|
| Mg²⁺ | −1830 | −1949 | n.a. |
| Ca²⁺ | −1505 | −1602 | n.a. |
| Ba²⁺ | −1250 | −1332 | −205 |
| Li⁺ | −475 | −531 | −142 |
| Na⁺ | −365 | −416 | −111 |
| K⁺ | −295 | −334 | −74 |
| NH₄⁺ | −285 | −329 | −112 |
| Me₄N⁺ | −218 | — | — |
| Imidazolium | −269 | — | — |
| n-propylguanidinium | −250^{a} | — | — |
| Guanidinium | −324^{a} | — | — |
| PO₄³⁻ | −2765 | −2879 | n.a. |
| CO₃²⁻ | −1315 | −1397 | n.a. |
| SO₄²⁻ | −1080 | −1035 | −200 |
| F⁻ | −465 | −510 | −137 |
| Cl⁻ | −340 | −367 | −75 |
| Br⁻ | −315 | −336 | −59 |
| NO₃⁻ | −300 | −312 | −76 |
| I⁻ | −275 | −291 | −36 |
| SCN⁻ | −280 | −311 | −66 |
| ClO₄⁻ | −430 | −246 | −57 |
| BF₄⁻ | −190 | −227 | −66 |

^{a}value calculated via molecular modelling

As used herein, the term “liquid-liquid interface” refers to a surface forming the common boundary between two adjacent non-miscible liquids, such as oil and water. In some cases, a liquid-liquid interface may also be referred to more simply as a fluid interface.

As used herein, the term “interfacial tension” refers to the energy of a liquid-liquid interface, and quantitatively describes the tendency of a liquid to minimize its interfacial area. Examples of methods used to determine interfacial tension include, but are not limited to, maximum bubble pressure, axisymmetric drop or bubble shape, du Nouy ring, Wilhelmy plate, spinning drop and drop weight methods. Interfacial tension is commonly reported in units of mN m⁻¹, numerically equivalent to dynes cm⁻¹.

As used herein, the term “surfactant” or “surface-active agent” refers to a chemical agent capable of lowering the interfacial tension at a liquid-liquid interface, for example by adsorbing at the liquid-liquid interface. Surfactants have a polar moiety and a non-polar moiety providing an affinity for the liquid-liquid interface. Examples of surfactants include anionic surfactants, non-ionic surfactants, cationic surfactants and zwitterionic or amphoteric surfactants. Ionic surfactants include anionic surfactants such as alkylsulfonates, alkylsulfates, alkylphosphates, long chain carboxylates and long chain perfluorocarboxylates, cationic surfactants such as long chain amines and alkylamines, zwitterionic surfactants and polyelectrolyte surfactants such as some peptides.

As used herein the term “affinity for the liquid-liquid interface” means that surfactants from a bulk solution are attracted to or adsorbed at the liquid-liquid interface such that the concentration of surfactant at the liquid-liquid interface is greater than the concentration of surfactant in the bulk solution. In general, the surfactants have hydrophobic and hydrophilic regions and align themselves at the interface to minimize their free energy on adsorption, typically such that their hydrophobic region is in contact with a non-polar portion of the interface and their hydrophilic region is in contact with a polar portion of the interface.

As used herein, the term “emulsion” refers to a suspension or dispersion of a first liquid suspended or dispersed in a second liquid in which the first liquid is poorly soluble or non-miscible. The first liquid is referred to as the dispersed phase and the second liquid is referred to as the continuous phase. The dispersed phase may form droplets which are dispersed throughout the continuous phase in a heterogeneous or homogeneous manner. Illustrative examples of emulsions include oil-in-water emulsions in which the oil forms the dispersed phase and the water forms the continuous phase, and water-in-oil emulsions in which the water forms the dispersed phase and the oil forms the continuous phase. In addition, “multiple emulsions” may be formed in which droplets of a first discontinuous phase contain smaller droplets of a second discontinuous phase, which may or may not be similar in composition to the continuous phase containing the first discontinuous phase. Illustrative examples of multiple emulsions include water-in-oil-in-water emulsions in which oil forms the first discontinuous phase and water forms the second discontinuous phase, and oil-in-water-in-oil emulsions in which the water forms the first discontinuous phase and oil forms the second discontinuous phase.

As used herein, the term “peptide” refers to two or more naturally occurring or non-naturally occurring amino acids joined by peptide bonds. Generally, peptides will range from about 2 to about 80 amino acid residues in length, usually from about 5 to about 60 amino acid residues in length and more usually from about 5 to 40 or 10 to about 40 amino acid residues in length. The peptide may also be a retro-inverso peptide.

As used herein, the term “salt” refers to a chemical entity in which positive and negative ions combine to give a composition without a net positive or negative charge. In some cases, a salt forms a liquid at or near room temperature and may be referred to as an “ionic liquid”. Ionic liquids generally comprise bulky, asymmetric cations such as 1-alkyl-3-methylimidazolium, 1-alkylpyridinium or N-methyl-N-alkylpyrrolidinium paired with inorganic anions such as tetrafluoroborate or hexafluorophosphate or large organic anions like bistriflimide, triflate or tosylate. Some examples of ionic liquids include ethylammonium nitrate and 1-butyl-3-methylimidazolium tetrafluoroborate.

As used herein, the term “zeta potential” refers to a measure of the magnitude of the electrostatic repulsion or attraction between colloidal particles. It is derived from electrophoretic mobility measurements and represents the electric potential in the interfacial double layer at the slipping plane relative the bulk fluid. A value of 25 mV (positive or negative) can be taken as the arbitrary value that separates low-charged surfaces from highly-charged surfaces. For particles that are small enough, a high zeta potential will confer stability, i.e. a solution or dispersion will resist aggregation. Colloids with a high zeta potential (negative or positive) are electrically stabilized while colloids with a low zeta potential tend to flocculate.

As used herein, the “critical micelle concentration” (CMC) of a surfactant refers to the concentration above which micelles of surfactant form in solution. Micelles are surfactant aggregates containing commonly 70-80 monomers, in which the surfactant headgroups are exposed to the polar solvent, while the hydrophobic tails aggregate to form an unstructured core. Critical micelle concentrations vary from one surfactant to another and may also vary with temperature, salt, etc. The CMC of a surfactant may be determined by monitoring changes in surface tension as the surfactant concentration increases. Below the CMC, the surface tension drops steeply with concentration, while above the CMC the surface tension remains almost constant.

As used herein, the term “Jones-Dole viscosity B coefficient” refers to a parameter relating the concentration of a salt in water to the viscosity of the salt solution. The viscosity of a salt solution can be readily measured, for example by determining the time required for the solution to flow through a small hole in the bottom of a tube. The results can be fitted to the following polynomial in c, the concentration of the salt, up to about 0.1 M for strong electrolytes with a 1:1 ion ratio (e.g. NaCl):

$$\frac{η}{{η}_{0}} = 1 + A \sqrt{c} + B \cdot c , \qquad ( Equation 2 )$$

where η is the viscosity of the salt solution, η₀ is the viscosity of pure water at the same temperature, A is an electrostatic term that, is close to 1 for moderate salt concentrations, and B is the Jones-Dole viscosity B coefficient, a direct measure of the strength of ion-water interactions, normalized to the strength of water-water interactions in bulk solution (Collins 2004). In one approach, kosmotropes are defined as ions having a positive Jones-Dole viscosity B coefficient, whereas chaotropes are defined as ions with a negative Jones-Dole viscosity B coefficient, whereby it should be noted that this approach defines sodium as slightly kosmotropic and chloride as slightly chaotropic. Some representative values of Jones-Dole viscosity B coefficients are given in Table 3.

TABLE 3
Jones-Dole viscosity B coefficients of selected ions (Collins 2004)

| Cation | B | Anion | B |
|---|---|---|---|
| Mg²⁺ | 0.385 | PO₄³⁻ | 0.590 |
| Ca²⁺ | 0.285 | CH₃COO⁻ | 0.250 |
| Ba²⁺ | 0.22 | SO₄²⁻ | 0.208 |
| Li⁺ | 0.150 | F⁻ | 0.100 |
| Na⁺ | 0.086 | Cl⁻ | −0.007 |
| K⁺ | −0.007 | Br⁻ | −0.032 |
| NH₄⁺ | −0.007 | NO₃⁻ | −0.046 |
| Rb⁺ | −0.030 | ClO₄⁻ | −0.061 |
| Cs⁺ | −0.045 | I⁻ | −0.068 |
| | | SCN⁻ | −0.103 |

As used herein, the term “alkyl” refers to monovalent, straight chain or branched hydrocarbon groups, having 1 to 10 carbon atoms as appropriate. For example, suitable alkyl groups include, but are not limited to, methyl, ethyl, propyl, isopropyl, n-butyl, sec butyl, tert-butyl, pentyl, 2-methylpentyl, 3-methylpentyl, n-hexyl, 2-, 3- or 4-methylhexyl, 2-, 3- or 4-ethylhexyl-, heptyl, octyl, nonyl and decyl.

As used herein, the term “cycloalkyl”, refers to cyclic hydrocarbon groups. Suitable cycloalkyl groups include, but are not limited to, cyclopropyl, cyclobutyl, cyclopentyl and cyclohexyl.

The term “aryl” as used herein, refers to C₆-C₁₂ aromatic hydrocarbon groups in which at least one ring is aromatic, such as phenyl, naphthyl, biphenyl and tetrahydronaphthylene.

The term “heterocyclyl” or “heterocyclic” as used herein, refers to monocyclic, polycyclic, fused or conjugated cyclic hydrocarbon residues, preferably C₃₋₆, wherein one or more carbon atoms (and where appropriate, hydrogen atoms attached thereto) are replaced by a heteroatom so as to provide a non-aromatic residue. Suitable heteroatoms include, O, N and S. Where two or more carbon atoms are replaced, this may be by two or more of the same heteroatom or by different heteroatoms. Suitable examples of heterocyclic groups may include, but are not limited to, pyrrolidinyl, pyrrolinyl, piperidyl, piperazinyl, morpholino, indolinyl, imidazolidinyl, pyrazolidinyl, thiomorpholino, dioxanyl, tetrahydrofuranyl, tetrahydropyranyl, tetrahydropyrrolyl.

The term “heteroaryl” or “heteroaromatic”, as used herein, represents a stable monocyclic or bicyclic ring of up to 6 atoms in each ring, wherein at least one ring is aromatic and contains from 1 to 4 heteroatoms selected from the group consisting of O, N and S. Heteroaryl groups within the scope of this definition include, but are not limited to, acridinyl, carbazolyl, cinnolinyl, quinoxalinyl, pyrrazolyl, indolyl, benzotriazolyl, furanyl, thienyl, benzothienyl, benzofuranyl, quinolinyl, isoquinolinyl, oxazolyl, isoxazolyl, indolyl, pyrazinyl, pyridazinyl, pyridinyl, pyrimidinyl, pyrrolyl, tetrahydroquinoline.

Alkyl, cycloalkyl, heterocyclyl, heteroaryl and aryl groups of the invention may be optionally substituted with 1 to 5 groups selected from —OH, —OC₁₋₆alkyl, —Cl, —Br, —NH₂, —NH(C₁₋₆ alkyl), —N(C₁₋₆alkyl)₂, —SH, —CO₂H, —CO₂C₁₋₆alkyl, —CONH₂, —CONH(C₁₋₆alkyl) or —CON(C₁₋₆alkyl)₂.

As used herein, the term “divalent bridging group” refers to a radical that has a valence of two and is able to bind with two other groups. Examples of suitable divalent bridging groups include, but are not limited to, —(CH₂)ₜ— where t is an integer from 1 to 10, —O—, —S—, a divalent saturated or aromatic carbocyclic ring or a heterocyclic or heteroaromatic ring or a combination of such divalent and/or cyclic moieties. For example a saturated C₆ cyclic group would include —C₆H₁₀—, a C₆ aromatic group would include —C₆H₄—, a C₆ heterocyclic group would include

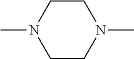

and a C₆ heteroaromatic would include

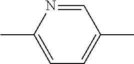

Other divalent bridging groups include alkylene groups (—CH₂—)ₜ in which one or more carbon atoms have been replaced by NH, S, O,

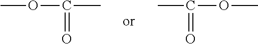

In a preferred embodiment the divalent bridging group is —(CH₂)ₜ— where t is an integer from 1 to 10, especially 1 to 6, more especially 6.

As used herein, the term “tautomer” refers to isomeric forms of a compound which have migration of a hydrogen atom accompanied by movement of adjacent double bonds. For example, Formula (I) may tautomerise to provide different isomers according to the following equation:

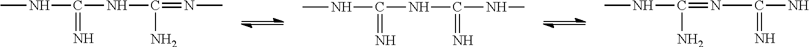

As used herein, the term “coalescence” refers to the process in which two droplets in an emulsion come into contact with one another and merge to form a single droplet.

As used herein, the term “phase separation” refers to the occurrence of multiple coalescence events resulting in the two phases of the emulsion separating.

The term “HLB” refers to the hydrophobic-lipophilic balance of a surfactant mixture. This term is a measure of the degree of hydrophilicity or lipophilicity of a surfactant. The HLB value is obtained by dividing the mass of the hydrophilic portion of the surfactant molecule with the mass of the whole surfactant molecule. An HLB of 0 indicates a completely hydrophobic molecule while an HLB of 20 indicates a completely hydrophilic molecule. Typically an HLB value of 4-6 indicates the surfactant may act as a water-in-oil emulsifier and an HLB value of 8-18 indicates the surfactant molecule may act as an oil-in-water emulsifier.

### Methods for Controlling Emulsion Coalescence

In one aspect of the present invention, there is provided a method of controlling coalescence and/or phase separation of an emulsion stabilized by an ionic surfactant comprising adding to the emulsion a chaotropic counterion.

Surfactants suitable for use in the invention may be any charged surfactants commonly used in industrial applications, including anionic, cationic and zwitterionic (amphoteric) surfactants. The surfactants have an affinity for the liquid-liquid interface and provide stabilization of the emulsion droplet discontinuous phase from coalescence and/or phase separation. Anionic surfactants may include, but are not limited to, alkyl sulfates, alkyl ethoxy sulfates, alkyl sulfonates, α-olefin sulfonates, ether sulfonates, fatty acid ester sulfonates, alkylaryl sulfonates, acyl isothionates, sulfosuccinate mono- and diesters, fatty acid N-methyltaurides, fatty acids, ether carboxylates, amidocarboxylates, acyl sarcosinates, alkyl phthalamates, phosphate esters, phospholipids and anionic gemini or bolaform surfactants. Cationic surfactants may include, but are not limited to, primary, secondary, tertiary or quaternary alkylamines, ester quaternary amines and heterocyclic cationics. Amphoteric (zwitterionic) surfactants may include, but are not limited to, aminopropionates, iminodipropionates, hydroxyethyl alkyl imidazolines, amphoacetates, amphodiacetates, amphopropionates, amphodipropionates, sulfonated amphoterics, betaines, sultaines (sulfated betaines), hydroxysultaines, amphohydroxypropylsulfonates, phosphobetaines, phosphoamphoterics, or polymeric surfactants including peptides. Peptides suitable for use in the invention may be any peptides that have an affinity for a liquid-liquid interface and carry a net-positive or negative charge under the conditions of use. For the purposes of the invention, peptides that interact with one another at the liquid-liquid interface to form a force-transmitting network, as described in WO 2006/089346, under the conditions of use may be less effective than peptides that do not form such a network. Examples of peptides suitable for use as surfactants in the invention include, but are not limited, to:

SEQ ID NO: 1
Ac-MEELADS LEELARQ VEELESA-CONH₂
SEQ ID NO: 2:
Ac-LEELADS LEELAEQ VEELLSA-CONH₂
SEQ ID NO: 3
Ac-EISALEA EISALEA EISALEA-CONH₂
SEQ ID NO: 4
Ac-AISELEAEISALEAEIESLAA-NH₂
SEQ ID NO: 5
Ac-AIESLAESIEELAEAISELAA-NH₂
SEQ ID NO: 6
Ac-MKQLADS LHQLARQ VSRLEHA-CONH₂
SEQ ID NO: 7
Ac-MKQLADS LHQLAHK VSHLEHA-CONH₂
SEQ ID NO: 8
H₂N-P LAEIDSA LAEIEAQ VAELIAA VED-COOH
SEQ ID NO: 9
H₂N- P LEAIADS LEAIAEQ VEALIEA VAD-COOH
SEQ ID NO: 10
H₂N-PG IAELEAE LSAVEAE LEAILAE LD-COOH
SEQ ID NO: 11
Ac-LAELESL LAELEAL VAELLSA-CONH₂

Surfactants suitable for use in the invention may also include fluorinated or perfluorinated analogs of surfactants listed herein. In some cases, the hydrophile-lipophile balance (HLB) of the surfactant may be suitable for the preparation of an oil-in-water emulsion. In some cases, the HLB of the surfactant may be suitable for the preparation of a water-in-oil emulsion.

In some embodiments, the surfactant is a natural surfactant which stabilizes an emulsion that is formed during a process such as extraction of substance from organic materials. Such natural surfactants may contain only one surfactant compound but are more likely to be a mixture of surfactant compounds such as fatty acids, peptides, phospholipids, sterols and sterol derivatives. Natural surfactants may be released from cell walls during an extraction process and form a stable emulsion with the extraction solvents. These stable emulsions can be difficult to break to provide phase separation and efficient extraction of the desired products, at least in part because of the variety of surfactant polar ionic and non-ionic moieties and because at least some of these moieties have kosmotropic properties. However, the addition of chaotropic counterions, especially polyvalent counterions, in accordance with the present invention may provide controlled coalescence and/or phase separation of these stabilised emulsions.

Oils suitable for use in the invention are any oils that have poor solubility in water. Suitable oils include, but are not limited to, hydrocarbons including hexane, heptane, octane, decane, dodecane, tetradecane, hexadecane, octadecane, benzene and toluene; halogenated hydrocarbons including dichloromethane, chloroform and carbon tetrachloride; mineral oils including paraffinic, naphthenic or aromatic oils; crude oils; silicone oils; synthetic oils including poly-alphaolefins and synthetic esters; vegetable oils including olive oil, peanut oil, sesame oil, sunflower oil, cottonseed oil, caster oil, rapeseed oil, palm oil, soybean oil, coconut oil, and blended oils; synthetic triglycerides; alpha-tocopherol and terpenes. Oils suitable for use in the invention may also include fluorinated or perfluorinated analogs of oils listed herein.

Aqueous phases that are suitable for use in the invention include water or mixtures of water with other polar miscible solvents such as methanol and ethanol. The aqueous phase may also be a buffer solution such as borate buffer, Tris buffer, citrate buffer, acetate buffer, formate buffer, phosphate buffer or HEPES buffer. However, if the buffer solutions contain ions, for example co-ions, a greater amount of chaotropic counterion will be required to achieve coalescence and/or phase separation.

The minimum size of surfactant-saturated emulsion droplets that can be produced in an oil-in-water emulsion for a given oil volume fraction and surfactant concentration is given by:

$${d}_{min} = \frac{6 \cdot {Γ}_{sat} \cdot ϕ}{{C}_{s}} \qquad Equation ( 3 )$$

where dₘᵢₙ is the minimum droplet diameter (in m), Γₛₐₜ is the excess surface concentration of the surfactant (in kg m⁻²), φ is the oil volume fraction and Cₛ is the surfactant concentration in the total emulsion (in kg m⁻³). The relation may also be given as:

$${d}_{min} = \frac{6 \cdot {Γ}_{sat} \cdot φ}{{C}_{s} \cdot ( 1 - ϕ )} \qquad Equation ( 4 )$$

where C′ₛ is the surfactant concentration in the aqueous phase. The relations are given for the case of a monodisperse emulsion, in which all droplets have the same size. For a polydisperse emulsion in which the emulsion droplets have different sizes, the appropriate diameter is the volume-surface mean diameter or Sauter mean diameter:

$${d}_{32} = \frac{{\sum }_{i = 1}^{ } {n}_{i} {d}_{i}^{3}}{{\sum }_{i = 1}^{ } {n}_{i} {d}_{i}^{2}} , \qquad Equation ( 5 )$$

which can be calculated from a table of size distribution frequencies, as available from commercial sizing instruments such as the Nano Zetasizer ZS (Malvern Instruments).

Counterions suitable for use in the present invention are chaotropic ions that associate with a surfactant stabilizing the emulsion where the surfactant has a charged moiety opposite to that of the chaotropic ion. The chaotropic ion is therefore a counterion with the surfactant and may result in one or more effects including but not limited to an increase in adsorption of the surfactant at the liquid-liquid interface, a decrease in the critical micelle concentration (cmc), a decrease in the magnitude of the zeta potential of the emulsion droplets such that a positive or negative zeta potential moves closer to zero, a decrease in the solubility of the surfactant in the aqueous phase of the emulsion and/or an increase in the solubility of the surfactant in the oil phase of the emulsion.

In some embodiments, the chaotropic ion is monovalent. In other embodiments, the chaotropic ion is polyvalent. In some embodiments, the chaotropic ion is a strongly chaotropic counterion, especially a strongly chaotropic multivalent counterion.

Monovalent ions for use in the invention are organic or inorganic chaotropic ions having a low charge density and high polarizability, resulting in relatively poor solvation by water. Such ions may be characterized by a negative Jones-Dole viscosity B coefficient. A large number of cations and anions meeting this requirement are known from the field of ionic liquids, where pairs of such ions are used to form polar non-aqueous solvents, particularly such cases where the ion pair forms a liquid at room temperature (Zhang, Sun et al. 2006).

For the purposes of this invention, anionic counterions containing carboxylate groups may be less useful than those containing phosphate, phosphonate, sulfate or sulfonate groups, due to stronger hydration of the carboxylate group. In addition, counterions having surfactant activity in their own right, such as organic ions attached to aromatic or long-chain alkyl moieties, may be less useful for the purposes of the invention, due to the capacity of these ions to stabilize emulsions in their own right. Such surfactant counterions are not favoured for use in the present invention.

Singly-charged chaotropic anionic counterions suitable for use in the present invention include but are not limited to, tetrabromoaluminate (AlBr₄⁻), tetrachloroaluminate (AlCl₄⁻), heptachlorodialuminate (Al₂Cl₇⁻), hexafluoroarsenate (AsF₆⁻), tetrachloroaurate (AuCl₄⁻), tetrachloroborate (BCl₄⁻), chlorotrifluoroborate (BClF₃⁻), tetrafluoroborate (BF₄⁻), chlorate (ClO₃⁻), perchlorate (ClO₄⁻), tetrachloroindate (InCl₄⁻), iodide (F), triiodide (I₃⁻), tetrachlorogallate (GaCl₄⁻), hexafluoroniobate (NbCl₄⁻), nitrate (NO₃⁻), hexachloroosmate (OsCl₄⁻), hexafluorophosphate (PF₆⁻), hexafluoroantimonate (SbF₆⁻), hexafluorotantanate (TaF₆⁻), hexafluorotitanate (TiF₆⁻), thiocyanate (SCN⁻), bisulfate (hydrosulfate, HSO₄⁻), methanesulfonate (CH₃SO₃⁻), trifluoromethane sulfonate (triflate, CF₃SO₄⁻), perfluorobutanesulfonate (C₄F₉SO₃⁻), methylsulfate (CH₃OSO₃⁻), ethylsulfate (CH₃CH₂OSO₃⁻), methoxyethylsulfate (CH₃OCH₂CH₂OSO₃⁻), ethoxyethylsulfate (CH₃CH₂OCH₂CH₂OSO₃⁻), 4-methylbenzenesulfate (tosylate, 4-CH₃—C₆H₄—SO₃⁻), tris(pentafluoroethyl)trifluorophosphate ([C₂F₅]₃F₃F), dimethylphosphate ([CH₃O]₂P(O)O⁻), diethylphosphate ([CH₃CH₂O]₂P(O)O⁻), dipropylphosphate ([C₃H₇O]₂P(O)O⁻), dibutylphosphate ([C₄H₉]₂OP(O)O⁻), imidodiphosphorylfluoride ([P(O)(F)₂]₂N⁻), imidodisulfurylfluoride ([S(O)₂F]₂N), dicyanamide ([CN]₂N), triflide (methide, [S(O)₂CF₃]C⁻), bis(trifluoromethylsulfonyl)imide ([S(O)₂CF₃]₂N) and bis(pentafluoroethylsulfonyl)imide (Beti, [S(O)₂CF₂CF₃]₂N⁻), especially perchlorate, iodide, triiodide, hexafluorophosphate, thiocyanate, bisulfate, methanesulfonate, trifluoromethanesulfonate, perfluorobutanesulfonate, methylsulfate, ethylsulfate, methoxyethylsulfate, ethoxyethylsulfonate and tosylate.

Singly-charged chaotropic cations suitable for use in the invention include, but are not limited to, trimethylsulfonium (trimesium, (CH₃)₃S⁺), butyltrimethylphosphonium ([C₄H₉][CH₃]₃P⁺), pyridinium (C₅H₆N⁺), 1-methylpyridinium (C₅H₅N⁺CH₃), 1-ethylpyridinium (C₅H₅N⁺CH₂CH₃), 1-propylpyridinium (C₅H₅N⁺C₃H₇), 1-butylpyridinium (C₅H₅N⁺C₄H₉), 1-ethyl-2-methylpyrazolium (C₃H₃N[CH₃]N⁺[C₂H₅]), 1-methyl-1-pentylpyrrolidinium (C₄H₈N⁺[CH₃][C₅H₁₁]), imidazolium (C₃H₃NHN⁺H), 1-methylimidazolium (C₃H₃NHN⁺CH₃), 1-ethylimidazolium (C₃H₃NHN⁺CH₂CH₃), 1-proplyimidazolium (C₃H₃NHN⁺C₃H₇), 1-butylimidazolium (C₃H₃NHN⁺C₄H₉), 1-(2-hydroxyethyl)-3-methylimidazolium (C₃H₂[CH₂CH₂OH]NHN⁺[CH₃]), 1,2,3-trimethylimidazolium (C₃H₂[CH₃]N⁺[CH₃]N⁺[CH₃]), 1-ethyl-3-methylimidazolium (C₃H₂N[CH₂CH₃]N[CH₃]), 1,2-diethyl-3-methylimidazolium (C₂H₃[CH₂CH₃]N[CH₂CH₃]N⁺[CH₃]), 1,3-diethyl-4-methylimidazolium (C₃H₂[CH₃]N[CH₂CH₃]N⁺[CH₂CH₃]), 1-methyl-3-(2-methylpropyl)imidazolium (C₃H₃N[CH₃]N⁺[CH₂CH₃)₂]), 1,3-diethylimidazolium (C₃H₃N[CH₂CH₃]N⁺[CH₂CH₃]), 1-ethyl-2,3-dimethylimidazolium (C₃H₂[CH₃]N[CH₂CH₃]N⁺[CH₂CH₃]), 1-(1,1-difluoroethyl)-3-(trifluoromethyl)imidazolium (C₃H₃N[CF₂CH₃]N⁺[CF₃]), thiazolium (C₃H₃SN⁺H), 3-methylthiazolium (C₃H₃SN⁺CH₃), 3-ethylthiazolium (C₃H₃SN⁺CH₂CH₃), 3-propylthiazolium (C₃H₃SN⁺C₃H₇), 3-butylthiazolium (C₃H₃SN⁺C₄H₉), 3-butyl-5-methylthiazolium (C₃H₂[CH₃]SN⁺C₄H₉] and guanidinium (NH₂)₂C═NH₂⁺), especially pyridinium, imidazolium and guanidinium.

Polyelectrolytes suitable for use as counterions in the invention are oligomers or polymers containing multiple ionic moieties that are not strongly solvated and are capable of accumulating at an interface in the presence of a surfactant containing an oppositely charged ion. Ionic moieties of this kind will in many cases be chemically similar to the singly-charged ions listed above. While certain counterions, for example, iodide and thiocyanate, cannot be incorporated into a polymer without loss of charge, many others, especially organic ions, possess sites suitable for crosslinking into oligomer or polymer forms. Polyelectrolytes of this kind are suitable for use at much lower concentrations, and hence lower cost than singly-charged ions, as the physical connection between the ionic groups leads to a higher effective concentration at the interface.

In some embodiments, the polyelectrolyte counterions have a molecular weight range in the order of 500 to 10,000 Da, especially 500 to 5,000 Da, more especially 500 to 2,000 Da.

One category of polyelectrolytes suitable for use as counterions in the invention include oligomers or polymers having multiple sulfate, sulfonate, phosphate, phosphonate, phosphite, nitrate, chlorate or perchlorate groups or a combination of these groups. Such anionic polymers are suitable for controlled coalescence of emulsions prepared with cationic surfactants.

A second category of polyelectrolytes suitable for use as counterions in the invention comprises oligomers or polymers with multiple guanidinium, biguanide or bispyridinamide groups, such as octenidine, chlorhexidine, poly(hexamethylene biguanide) and similar chemical entities. Such cationic polymers are suitable counterions for controlled coalescence of emulsions prepared with anionic surfactants.

Examples of multivalent anions that are suitable for use in the invention include but are not limited to polyphosphates of formula (I):

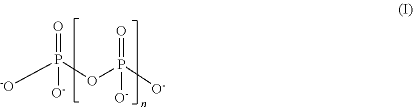

wherein n is an integer from 1 to 20, especially 1 to 10, more especially 1 to 5, such as pyrophosphate ([P(O)O₂²⁻]O) and polyphosphate (([P(O)O₂²⁻]O[P(O)O₂²⁻]O[(P(O)O₂²⁻]), polyvinylsulfonates of the formula (II):

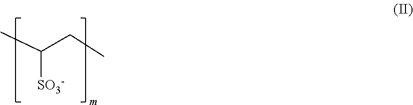

wherein m is 1 to 20, especially 1 to 10, poly(styrene-4-sulfonates) of formula (III):

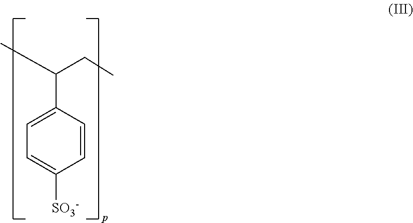

wherein p is 1 to 20, especially 1 to 10.

Biguanides of formula (IV):

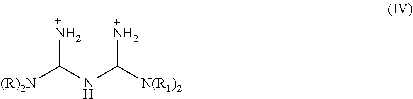

wherein each R and each R₁ is independently selected from hydrogen, alkyl, cycloalkyl, aryl or alkylaryl wherein each aryl may be substituted with —C₁₋₄alkyl, halo, —OC₁₋₄alkyl, including biguanide, metformin, phenformin, buformin and proguanil.

Bisbiguanides of formula (V):

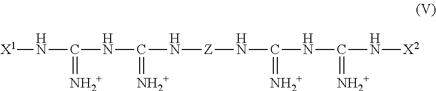

or a tautomer thereof, wherein Z is a divalent bridging group and X¹ and X² are independently selected from optionally substituted alkyl, optionally substituted aryl, optionally substituted cycloalkyl, optionally substituted heterocyclyl or optionally substituted heteroaryl or a pharmaceutically or veterinarily acceptable salt thereof. The above bis(biguanide) compounds and methods for their preparation are described, for example, in U.S. Pat. Nos. 4,670,592 and 4,952,704. In some embodiments, the bis(biguanides) include chlorhexidine (commercially available from various sources such as Degussa AG of Dusseldorf, Germany), where X¹ and X² are both 4-chlorophenyl and Z is —(CH₂)₆— and alexidine (commercially available from Ravensberg GmbH Chemische Fabrik, Konstanz, Germany), where X¹ and X² are both 3-ethylhexane and Z is —(CH₂)₆—.

Polybiguanides such as those described by East et al., (1997) in which the biguanide appears in the polymer backbone especially polybiguanides of formula (VI):

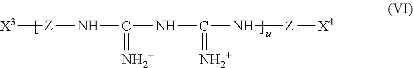

or a tautomer thereof, wherein Z is absent or an organic divalent bridging group and each Z may be the same or different throughout the polymer; u is at least 3, preferably 5 to 20 and X³ and X⁴ are independently selected from —NH₂, —NH—C(═NH)—NH—CN, optionally substituted alkyl, optionally substituted cycloalkyl, optionally substituted aryl, optionally substituted heterocyclyl and optionally substituted heteroaryl; or a pharmaceutically or veterinarily acceptable salt thereof. In some embodiments, the molecular weight of the polymeric compound is at least 1,000 amu, especially between 1,000 amu and 50,000 amu. In a single composition, u may vary providing a mixture of polymeric biguanides. In some embodiments, the polymeric biguanides have a mean molecular weight in the region of 2,900 to 15,000, especially 3,000 to 8,000, and particularly 3,200 to 5,000, especially 3,500 to 4,500. The above polymeric biguanide compounds and methods for their preparation are described in, for example, U.S. Pat. No. 3,428,576 and East et al., (1997).

In some embodiments; the polymeric biguanides in which the biguanide appears in the backbone of the polymer for use in the invention are polymeric hexamethylene biguanides of formula (VI) such as polyhexanide or PHMB (commercially available as Vantocil, Baquacil, Arlagard, Lonzabac BG or Cosmocil) of the following formula:

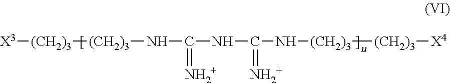

or a tautomer thereof, wherein u is an integer from 3 to 500 and X³ and X⁴ are independently selected from —NH₂, —NH—C(═NH)—NH—CN, optionally substituted alkyl, optionally substituted cycloalkyl, optionally substituted aryl, optionally substituted heterocyclyl and optionally substituted heteroaryl or a pharmaceutically or veterinarily acceptable salt thereof. In some embodiments, u has an average value of 3 to 15, more preferably 3 to 12.

In some embodiments, the polymeric biguanide is poly(hexamethylenebiguanide).

In some embodiments, the polyelectrolyte is octenidine ([n-C₈H₁₇]N⁺H═C₅H₄N—[CH₂]₁₀—NC₅H₄═N⁺H[n-C₈H₁₇]).

The counterions may be added to the emulsion in the form of a salt, that dissociates in the emulsion to provide the counterion.

The type of counterion used may depend, at least in part, on the identity of the surfactant. Surfactants suitable for stabilizing emulsions and that can be subject to controlled coalescence and/or phase separation in the present invention contain an ionic charged group as or as part of the polar moiety. The type of ionic charged group in the surfactant at least in part determines the strength of chaotropicity required in the counterion used to control coalescence and/or phase separation. An emulsion stabilized by a surfactant containing a chaotropic ionic moiety that is a large ion with low charge density and high polarizability that is weakly hydrated, such as sulfate or sulfonate, will be destabilized by all chaotropic counterions including those that are weakly chaotropic such as potassium ions or ammonium ions. An emulsion stabilized by a surfactant containing a kosmotropic ionic moiety that is a small ion with high charge density and low polarizability that is strongly hydrated, such as a carboxylate ion, will be destabilized by strongly chaotropic counterions, for example, polyelectrolyte counterions such as chlorhexidine, or polymeric biguanides of formula (VI). An emulsion stabilized by a surfactant containing an intermediate chaotropic ionic moiety such as a phosphate ion, will be destabilized by chaotropic counterions that have intermediate or strong chaotropic properties.

Example 3 demonstrates that an emulsion stabilized by sodium oleate surfactant is difficult to break with weak chaotropic counterions. Sodium oleate is a surfactant in which the polar ionic moiety is a carboxylic acid that has a tightly bound hydration sphere and is strongly kosmotropic. In this case, chaotropic counterions with a single charge such as potassium, ammonium and guanidinium were not able to cause coalescence or phase separation. A polyvalent chaotropic counterion was required to provide controlled coalescence and/or phase separation.

In some embodiments, the surfactant comprises a kosmotropic polar ionic moiety, such as a carboxylate ion and the chaotropic counterion is a polyelectrolyte. In some embodiments, the surfactant is a fatty acid surfactant such as oleic acid, palmitoleic acid, linoleic acid, linolenic acid, arachidonic acid, lauric acid, myristic acid, palmitic acid, stearic acid, arachidic acid, lignoceric acid or mixtures thereof. In some embodiments the surfactant is a peptide surfactant. In some embodiments, the chaotropic counterion is a biguanide, bisbiguanide or polybiguanide.

The amount of counterions added to provide coalescence and/or the phase separation of the emulsion will depend on the nature and concentration of the surfactant, the nature of the counterion and amounts of some additives and/or contaminants in the emulsion formulation. If an emulsion formulation has co-ions present, a greater amount of counterion will be required. In some instances, a co-ion may be present in an additive to the emulsion, such as a buffer. In some instances, a co-ion may be present in the emulsion as a contaminant, such as in a plant oil due to its extraction process or in a crude oil emulsion from a geological or drilling process. The amount is defined as a final concentration of counterion in the emulsion. A person skilled in the art could readily determine a suitable amount of counterion to give coalescence and/or phase separation. In general, a higher concentration of a singly-charged counterion will be required than a polyelectrolyte counterion. In some embodiments, the counterion will be present in the emulsion at a final concentration of between 0.0001 and 1 M, especially 0.001 and 1 M.

The amount of counterion required for efficient emulsion breaking can be determined in small-scale tests by adding increasing concentrations of counterion to emulsion samples under mixing, separating the coalesced oil phase after a fixed settling time, and quantifying the amount of oil released, for example by weighing. In general, the desired concentration of counterion for emulsion breaking will be close to or higher than the concentration of surfactant in the emulsion. For monomeric ions, the desired counterion concentration will be higher than the surfactant concentration by 2-fold to 1000-fold, especially 10-fold to 500-fold, more especially 50-fold to 100-fold. For polyelectrolytes, the desired counterion concentration, given as the concentration of singly-charged groups provided within the polyelectrolyte, will be close to the concentration of the surfactant in the emulsion, in the range of 0.7-fold to 5-fold, especially 0.8-fold to 2-fold, more especially 0.9-fold to 1.5-fold. In some cases, the addition of large excesses of multimeric counterions can reduce the efficiency of emulsion breaking. In the presence of co-ions, for example buffer ions, that are capable of binding to the counterion, the counterion concentration will need to be increased in approximately stoichiometric relation to the co-ion concentration.

In some embodiments, the term “controlling” refers to selecting a time or place suitable for coalescence and/or phase separation to occur. For example, the emulsion may remain in a stabilized condition for a desired period of time such as to allow diffusion of reactants or contaminants from one phase of the emulsion to another or until the emulsion has been transported to a desired location. The counterions may then be added to promote coalescence and/or phase separation at the desired time. In some embodiments, controlling refers to promoting phase separation.

### Applications

The control of emulsion coalescence may be useful in applications such as beverages, processed foods, pharmaceuticals, cosmetics, inks and printing, paints and coatings, surfactants, waste water treatment, explosives, bioremediation, organic material extraction, corrosion inhibition, drilling, oil recovery, medicine, dentistry, biocatalysis and biotechnology. The invention may be useful in a plurality of applications in which it is desirable to transfer a desired material from an oil to a water phase, or from a water to an oil phase. The invention may further be useful in a plurality of applications in which it is desirable to transfer an undesired material, such as a waste product or contaminant, from an oil to a water phase, or from a water to an oil phase. In these cases, initial formation of an emulsion allows stabilization of a large interfacial area in a finely dispersed oil-in-water or water-in-oil emulsion, enhancing the overall rate of transfer of a material from one liquid phase into another in which it is more soluble. Subsequent breaking of the emulsion and coalescence of the liquid phases allows recovery of a desired material in a separated oil or water phase depending on solubility. Alternatively, breaking of the emulsion and coalescence of the liquid phases allows removal of an undesired material, such as a waste product or contaminant, in a separated oil or water phase depending on solubility. For example, emulsion formation and breaking in this controlled manner may be useful in the extraction of natural products from biological sources. In a further example, emulsion formation and breaking in this manner may be useful in the removal of toxic materials, such as organic pesticides, from waste water. In yet another example, emulsion formation and breaking in this manner may be useful in the removal of corrosion-causing species from oil or more generally in enhanced oil recovery. The invention may further be useful in a plurality of applications in which it is desirable to promote a process or reaction that occurs exclusively or to an enhanced degree at the interface between a liquid and a second, immiscible liquid. For example, in applications where a catalyst present in a water phase acts on a reagent present in an oil phase, the catalysis occurring at the oil-water interface or by phase transfer into the second phase. Alternatively, in applications where a catalyst present in an oil phase acts on a reagent present in a water phase, the catalysis occurring at the oil-water interface or by phase transfer into the second phase. In these cases, initial formation of an emulsion allows stabilization of a large interfacial area in a finely dispersed oil-in-water or water-in-oil emulsion, enhancing the rate of the desired process, such as catalytic transformation of a less desired material into a more desired material or of an undesired material, such as a waste product or contaminant, into a less undesired material, such as a breakdown product of a waste product or contaminant. This process may optionally be followed by transfer of the transformed material from one liquid phase into another, depending on solubility. Subsequent breaking of the emulsion and coalescence of the liquid phases allows recovery of a more desired material in a separated oil or water phase depending on solubility. Alternatively, breaking of the emulsion and coalescence of the liquid phases allows removal of a less undesired material, such as a breakdown product of a waste product or contaminant, in a separated oil or water phase depending on solubility. The breaking of the emulsion may also allow recovery of a catalyst or excess reagent for recycling.

The application may further be useful in controlling the contact of a first material contained in the oil phase of a first oil-in-water emulsion with a second material contained in the oil phase of a second oil-in-water emulsion. The two oil-in-water emulsions are prepared and then combined together under a first set of conditions where coalescence of the oil droplets is inhibited, such that the first material and the second material are prevented from contacting each other. A suitable counterion is then added with the result that oil droplet coalescence occurs and the first material and the second material are able to contact each other. One application of this would be in controlling a chemical reaction between a first material and a second material in an oil phase. For example, reaction between a first material and a second material might be desired only after a specific time or in a specific physical location. In another illustrative example, the application may be useful in controlling the contact of a first material contained in the water phase of a first water-in-oil emulsion with a second material contained in the water phase of a second water-in-oil emulsion. The two water-in-oil emulsions are prepared and then combined together under a first set of conditions where coalescence of the water droplets is inhibited, such that the first material and the second material are prevented from contacting each other. A suitable counterion is then added with the result that water droplet coalescence occurs and the first material and the second material are able to contact each other. One application of this would be in controlling a chemical reaction between a first material and a second material in a water phase.

The invention may also be useful in the oil industry for oil recovery or cleaning up oil spills. For example, stabilization of an emulsion formed from oil and water in an oil well can allow easy extraction of the emulsion from the well. After the emulsion has been recovered, de-emulsification may be stimulated by addition of a counterion or ions. The oil and water phases may then be separated. Alternatively, after an oil spill, an oil-water emulsion may be stabilized by an added surfactant and recovered, then at a desired time a counterion or ions may be added allowing the phases of the emulsion to separate followed by recovery of the oil phase. This principle may be applied to waste water treatment in many industries where water is contaminated with an oil soluble contaminant. The oil soluble contaminant may be allowed to dissolve in an added oil phase during emulsion formation and stabilization. Then after adequate time for the contaminant to diffuse into the oil phase has elapsed, the emulsion could be broken by adding a counterion or ions. After phase separation, uncontaminated waste water may be recovered. The invention may also be useful in the oil industry for the transport of heavy oils. For example, emulsification of a heavy oil with a solution of surfactant in water may generate an oil-in-water or water-in-oil emulsion which is easier to pump or transport by other means than the same heavy oil not so emulsified. After the emulsion has been transported to a desired location, de-emulsification may be stimulated by addition of a specific counterion. The oil and water phases may then be separated.

### EXAMPLES

### Reagents

Reagents were analytical grade unless otherwise indicated. Ultrapure water for cleaning and solution preparation was produced using a MilliQ water purification unit (Millipore, North Ryde, NSW, Australia) and had a resistivity of >18.2 MΩ cm. Glassware was cleaned by soaking in 2% (v/v) Decon90 (Decon Laboratories Ltd, Hove, East Sussex, UK), rinsed extensively with water, soaked for 10 min in freshly prepared piranha solution (equal parts of 30% (v/v) H₂O₂ and 98% (v/v) H₂SO₄), then rinsed with copious amounts of water.

Sodium dodecyl sulfate (SDS), cetyltrimethylammonium bromide (CTAB), and cetylpyridinium chloride (CPC) were sourced from Sigma. Sodium dodecylbenzene sulfonate (SDOBS) was from Aldrich and was of technical grade. Potassium cetyl phosphate was from Sino Lion. Decane, dodecane, tetradecane and hexadecane were purchased from Sigma-Aldrich. In some cases, oils were cleaned of surface-active impurities by prolonged stirring with activated silica or aluminum oxide before use. In some cases, 5,10,15,20-tetraphenyl-21H,23H-porphine (TPP, Sigma) or Sudan III (Sigma) was dissolved at a low concentration (ca. 100 μM) in the oil phase to assist observation of emulsion breaking. Poly(dimethyldiallylammonium chloride) (MW<100,000 Da) and sodium poly(vinylsulfonate) (technical grade), and high molecular weight sodium poly(styrene-4-sulfonate) (70,000 Da) were from Sigma. Low molecular weight sodium poly(styrene-4-sulfonate) (1,100-6,500 Da) was a gift from Dr Michael Whittaker, The University of New South Wales. Chlorhexidine digluconate was from Sigma. Polyhexamethylene biguanide was from Tengarden Inc. (Ningbo, China). Tetraarginine (H₂N—RRRR—COOH) was custom synthesized and desalted by GenScript (Piscataway, N.J.). SEQ ID NO:1 (Ac-MEELADS LEELARQ VEELESA-CONH₂) and SEQ ID NO:6 (Ac-MKQLADS LHQLARQ VSRLEHA-CONH₂) were custom synthesized and purified to 95% by GenScript. Peptide SEQ ID NO:8 (H₂N-PLAEIDSA LAEIEAQ VAELIAA VED-COOH) was custom synthesized and desalted by Peptide 2.0 (Chantilly, Va.). Peptides were stored at −80° C.

### Emulsion Preparation

Oil-in-water emulsions were prepared by sonication of a surfactant solution with a predetermined volume of oil using either the micro probe or 10 mm horn of a Branson Sonifier 450 at maximum power. Sonication was carried out for 4×30 s cycles and the dispersion was cooled for 60 s on ice between sonication cycles. Alternately, oil-in-water emulsions were prepared using the 20 mm dispersing tool of an Omni rotor-stator homogenizer operating at 16,000-24,000 rpm for 1 minute at room temperature. Droplet sizing and zeta potential measurements used a Zetasizer NanoZS (Malvern Instruments Ltd, Worcestershire, UK) following dilution of emulsion samples either in water or a dilute surfactant solution.

Expected minimum droplet sizes corresponding to given surface excesses were calculated via:

$${d}_{min} = \frac{6 \times {Γ}_{sat} \cdot Φ}{{C}_{s}} \qquad ( Equation 3 )$$

where dₘᵢₙ is the minimum droplet diameter (in m), Γₛₐₜ is the surface excess of surfactant (in mg m⁻²), Φ is the oil volume fraction in the emulsion (unitless) and Cₛ is the surfactant concentration in the total emulsion (mg m⁻³).

### Emulsion Coalescence

An aliquot of emulsion (1 mL) was placed in a glass vial (4 mL) and stirred magnetically for 5-10 s after addition of an aliquot of salt (5-500 μL) sufficient to give a final salt concentration of 0.1-500 mM in the emulsion aqueous phase. The emulsion was then allowed to settle for 5 min. Any free oil that had separated was transferred into a pre-weighed vessel and the degree of emulsion coalescence was determined from the weight of oil recovered.

Where appropriate, solution ionic strengths (I) were determined using

$$I = \frac{1}{2} \cdot {\sum }_{i = 1}^{n} {c}_{i} \cdot {z}_{i}^{2} \qquad ( Equation 6 )$$

where c is the molar concentration of each ion and z is the ion charge.

### Example 1

### Controlled Coalescence of an Emulsion Prepared with Varying Concentrations of SDOBS. Effects of Different Cations (Chloride Salts) and Salt Concentrations

Emulsions were prepared by sonication of equal volumes (12 mL) of 1, 2, 5 and 10 mM aqueous SDOBS and ca. 100 μM TPP in decane. The emulsions were subjected to controlled coalescence studies by addition of chloride salts of different cations to give a desired final concentration in the aqueous phase. The extent of oil release (%) 5 min after addition of different chloride salts is given in Table 4. In separate tests, the extent of oil release (%) 5 min after addition of different concentrations of selected chloride salts was studied. The results are given in Tables 5-7. The results show that different singly-charged cations have different effectiveness in breaking an emulsion stabilized by a sulfonate surfactant, with the efficiency of breaking being higher for the chaotropic cations, guanidinium chloride and imidazolium chloride.

TABLE 4
Oil recovery after addition of chloride salts to a 50%
decane emulsion prepared with varying concentrations
of aqueous SDOBS

SDOBS (mM)

| | 1 | 2 | 5 | 10 |
|---|---|---|---|---|
| Guanidinium chloride | 73^{a} | 74^{b} | 92^{c} | 74^{d} |
| Imidazolium chloride | 60^{a} | 73^{b} | 61^{c} | 26^{d} |
| Tetramethylammonium | 26^{a} | 45^{b} | 37^{c} | 0^{d} |
| chloride | | | | |
| Ammonium chloride | 24^{a} | 40^{b} | 42^{c} | 0^{d} |
| Potassium chloride | 14^{a} | 40^{b} | 39^{c} | 0^{d} |
| Sodium chloride | 3^{a} | 27^{b} | 39^{c} | 0^{d} |
| Lithium chloride | 0^{a} | 28^{b} | 36^{c} | 0^{d} |
| Spermine | 95^{e} | 91^{f} | 90^{g} | 85^{h} |
| tetrahydrochloride | | | | |

^{a}ion concentration is 50 mM
^{b}ion concentration is 100 mM
^{c}ion concentration is 250 mM
^{d}ion concentration is 200 mM
^{e}ion concentration is 0.4 mM
^{f}ion concentration is 0.5 mM
^{g}ion concentration is 1.1 mM
^{h}ion concentration is 3.6 mM

TABLE 5
Oil recovery after addition of guanidinium chloride to a 50%
decane emulsion prepared with varying concentrations
of aqueous SDOBS

| | |
|---|---|
| Guanidinium | SDOBS (mM) |

| Chloride (mM) | 1 | 2 | 5 | 10 |
|---|---|---|---|---|
| 10 | 3 | — | — | — |
| 20 | 3 | — | — | — |
| 30 | 10 | — | — | — |
| 40 | 35 | 4 | — | — |
| 50 | 73 | — | 5 | 0 |
| 60 | — | 28 | — | — |
| 80 | 84 | 50 | — | — |
| 100 | 86 | 58 | 42 | 10 |
| 150 | — | 72 | 49 | 29 |
| 200 | 97 | 96 | 95 | 74 |
| 250 | — | — | 92 | — |

TABLE 6
Oil recovering after addition of lithium chloride to a 50%
decane emulsion prepared with varying concentrations
of aqueous SDOBS

SDOBS (mM)

| LiCl (mM) | 1 | 2 | 5 | 10 |
|---|---|---|---|---|
| 20 | 0 | — | — | — |
| 40 | 0 | — | — | — |
| 50 | — | 0 | 0 | 0 |
| 60 | 35 | — | — | — |
| 80 | 46 | — | — | — |
| 100 | 56 | 0 | 0 | 0 |
| 150 | — | 32 | 0 | 0 |
| 200 | 82 | 49 | 18 | 0 |
| 250 | — | — | 36 | — |

TABLE 7
Oil recovery after addition of spermine tetrahydrochloride
to a 50% emulsion prepared with varying concentrations
of SDOBS

| | |
|---|---|
| Spermine Tetra- | SDOBS (mM) |

| hydrochloride (mM) | 1 | 2 | 5 | 10 |
|---|---|---|---|---|
| 0.1 | 13 | 5 | — | — |
| 0.2 | 47 | 20 | — | — |
| 0.3 | 75 | 34 | 3 | — |
| 0.4 | 93 | 47 | — | — |
| 0.5 | 92 | 88 | 32 | — |
| 0.7 | — | — | 46 | — |
| 1.0 | 87 | 60 | 89 | — |
| 1.2 | — | — | — | 25 |
| 1.3 | — | — | 72 | — |
| 1.6 | — | — | 33 | — |
| 2.0 | 88 | 56 | 17 | — |
| 2.4 | — | — | — | 49 |
| 3.6 | — | — | — | 85 |
| 4.8 | — | — | — | 25 |

### Example 2

### Controlled Coalescence of Emulsions Prepared with Varying Concentrations of SDOBS. Effects of Tetraarginine

A series of emulsions was prepared by sonication of equal volumes (12 mL) of 1-100 mM aqueous SDOBS and tetradecane. Each emulsion was subjected to controlled coalescence by addition of tetraarginine peptide to give a desired final concentration in the aqueous phase. Oil recoveries after 5 or 60 minutes are given in Table 8 and Table 9. The results show that an oligomer containing multiple guanidinium groups can be an effective demulsifier even at high surfactant concentrations.

TABLE 8
Oil recovery (%) 5 min after addition of tetraarginine to a 50%
tetradecane emulsion prepared with 1 to 20 mM SDOBS

| | SDOBS (mM) | | | | |
|---|---|---|---|---|---|
| Tetra arginine (mM) | 1 | 2 | 5 | 10 | 20 |
| 0.2 | 27 | — | — | — | — |
| 0.3 | 85 | — | — | — | — |
| 0.3 | 96 | — | — | — | — |
| 0.4 | 94 | — | — | — | — |
| 0.5 | 89 | 75 | — | — | — |
| 0.6 | 83 | — | — | — | — |
| 0.7 | 82 | 95 | — | — | — |
| 1.0 | — | 84 | 61 | — | — |
| 1.1 | — | 68 | — | — | — |
| 1.4 | — | 65 | 85 | — | — |
| 1.7 | — | — | 89 | — | — |
| 2.0 | — | — | 80 | 73 | — |
| 2.3 | — | — | 72 | — | — |
| 2.7 | — | — | — | 86 | — |
| 2.9 | — | — | 48 | — | — |
| 3.3 | — | — | — | 77 | — |
| 3.8 | — | — | — | 73 | 71 |
| 4.6 | — | — | — | 71 | — |
| 5.3 | — | — | — | — | 75 |
| 5.7 | — | — | — | 65 | — |
| 6.5 | — | — | — | — | 72 |
| 7.4 | — | — | — | — | 70 |
| 9.1 | — | — | — | — | 70 |
| 10.7 | — | — | — | — | 72 |

TABLE 9
Oil recovery (%) 60 minutes after addition of tetraarginine
to a 50% tetradecane emulsion prepared with 50 or
100 mM SDOBS

| | |
|---|---|
| Tetra | SDOBS (mM) |

| arginine (mM) | 50 | 100 |
|---|---|---|
| 10.7 | 79 | — |
| 13.8 | 80 | — |
| 16.7 | 80 | 72 |
| 20.0 | — | 77 |
| 23.1 | 82 | 79 |
| 25.9 | — | 79 |

### Example 3

### Controlled Coalescence of an Emulsion Prepared with 3% (w/v) Sodium Oleate. Effects of Different Chloride Salts.

An emulsion was prepared by sonication of equal volumes (12 mL) of 3% (w/v) aqueous sodium oleate and hexadecane. The emulsion was subjected to controlled coalescence studies by addition of different chloride salts, lithium chloride, sodium chloride, potassium chloride, tetramethylammonium chloride and guanidinium chloride, to give a desired final concentration in the aqueous phase. No oil recovery was observed after 5 minutes. The results show that singly-charged cations are generally ineffective in breaking an emulsion stabilized by a strongly hydrated carboxylate-containing surfactant. Emulsion breaking tests were also carried out using addition of chlorhexidine digluconate (20% aqueous solution, ca. 0.22 M) to a desired final concentration in the aqueous phase. Oil recoveries after 5 minutes are given in Table 10. The results show that a bis-biguanide is effective causing coalescence and phase separation with strongly hydrated carboxylated surfactants.

TABLE 10
Oil recovery after addition of chlorhexidine digluconate
to a 50% hexadecane emulsion prepared with 3% (w/v)
aqueous sodium oleate.

| Chlorhexidine digluconate (mM) | Oil recovery (%) |
|---|---|
| 37 | 39 |
| 51 | 84 |
| 62 | 91 |
| 73 | 81 |

### Example 4

### Controlled Coalescence of an Emulsion Prepared with 5 mM Cetyltrimethylammonium-Bromide (CTAB). Effects of Different Sodium Salts

An emulsion was prepared by sonication of equal volumes (12 mL) of 5 mM aqueous CTAB and ca. 100 μM TPP in decane. The emulsion was subjected to controlled coalescence studies by addition of different sodium salts to give a desired final concentration in the aqueous phase. Oil recoveries after 5 minutes are given in Table 11. The results show that chaotropic anions are effective in breaking emulsions prepared with cationic surfactants.

TABLE 11
Oil recovery after addition of sodium salts to a 50%
decane emulsion prepared with 5 mM aqueous CTAB.

| Salt | Oil recovery (%) |
|---|---|
| Sodium thiocyanate (40 mM) | 68 |
| Sodium perchlorate (40 mM) | 65 |
| Sodium dihydrogen phosphate (40 mM) | 4 |
| Sodium nitrate (40 mM) | 2 |
| Sodium bromide (40 mM) | 1 |
| Sodium chloride (40 mM) | 0 |
| Sodium fluoride (40 mM) | 0 |

### Example 5

### Controlled Coalescence, of an Emulsion Prepared with 0.2 mM Peptide SEQ ID NO:6. Effects of Different Sodium Salts

An emulsion was prepared by sonication of equal volumes (12 mL) of 0.2 mM aqueous SEQ ID NO:6 in 10 mN HCl and ca. 100 μM TPP in 95:5 hexadecane:1-dodecanol. The emulsion was subjected to controlled coalescence studies by the addition of different sodium salts to give a desired final concentration in the aqueous phase. Oil recoveries after 5 minutes are given in Table 12. The results show that, as for cations, highly polarizable anions are also more effective in breaking emulsions prepared with oppositely charged ionic surfactants. The hydrosulfate ion is expected to be ca. 50% dissociated to sulfate under the conditions of switching, based on a Kₐ of 1.1×10⁻² M (Para and Warszynski 2007). The results further confirm that for polystyrene sulfonate, higher concentrations can be detrimental to efficient emulsion breaking.

Oil recovery (%) obtained with specific cations at specific concentrations are given in Tables 13 to 15.

TABLE 12
Oil recovery after addition of sodium salts to a 50% oil emulsion
prepared with 0.2 mM peptide SEQ ID NO: 6 in 10 mN HCl.
The oil phase was 5% (v/v) 1-dodecanol in hexadecane.

| Salt | Oil recovery (%) |
|---|---|
| Sodium poly(styrene-4-sulfonate) (2 mM)* | 89 |
| Sodium hydrosulfate (40 mM) | 96 |
| Sodium thiocyanate (40 mM) | 50 |
| Sodium perchlorate (40 mM) | 38 |
| Sodium dihydrogen phosphate (40 mM) | 16 |
| Sodium nitrate (40 mM) | 15 |
| Sodium bromide (40 mM) | 13 |
| Sodium chloride (40 mM) | 5 |

*Concentration with regard to sulfonate groups. Approximate polymer MW 1100.

TABLE 13
Oil recovery after addition of sodium hydrosulfate to a
50% oil emulsion prepared with 0.2 mM peptide SEQ ID
NO: 6 in 10 mN HCl. The oil phase was 5% (v/v)
1-dodecanol in hexadecane.

| Sodium hydrosulfate (mM) | Oil recovery (%) |
|---|---|
| 20 | 86 |
| 30 | 92 |
| 40 | 96 |
| 100 | 99 |

TABLE 14
Oil recovery after addition of sodium chloride to a 50%
oil emulsion prepared with 0.2 mM peptide SEQ ID NO: 6
in 10 mN HCl. The oil phase was 5% (v/v) 1-dodecanol
in hexadecane.

| Sodium chloride (mM) | Oil recovery (%) |
|---|---|
| 10 | 0 |
| 20 | 2 |
| 30 | 3 |
| 40 | 5 |
| 50 | 34 |
| 100 | 75 |

TABLE 15
Oil recovery after addition of sodium poly(styrene-4-sulfonate)
to a 50% oil emulsion prepared with 0.2 mM peptide SEQ ID
NO: 6 in 10 mN HCl. The oil phase was 5% (v/v) 1-dodecanol
in hexadecane.

| Sodium poly(styrene-4-sulfonate)* (mM) | Oil recovery (%) |
|---|---|
| 0.5 | 43 |
| 1.0 | 62 |
| 2.0 | 89 |
| 3.0 | 70 |
| 4.0 | 58 |
| 5.0 | 56 |

*Concentration with regard to sulfonate groups. Approximate polymer MW 1100.

### Example 6

### Controlled Coalescence of an Emulsion Prepared with 1 mM Peptide SEQ ID NO:1. Effects of Chlorhexidine Digluconate

An emulsion was prepared by sonication of equal volumes (12 mL) of 1 mM aqueous SEQ ID NO:1 pH 9.0 and dodecane. The emulsion was subjected to controlled coalescence studies by the addition of chlorhexidine digluconate (20% aqueous solution, ca. 0.22 M) to a desired final concentration in the aqueous phase. Oil recoveries after 5 minutes are given in Table 16. No oil release was observed on addition of 200 mM guanidinium chloride. The results show that a bis-biguanide can be a more effective demulsifier than guanidinium. The remaining emulsion was adjusted to pH 7 and emulsion breaking studies were repeated. Results are given in Table 17 and show chlorhexidine to be slightly more effective in breaking SEQ ID NO:1 emulsions at pH 7 than at pH 9.

TABLE 16
Oil recovery after addition of chlorhexidine digluconate to a
50% dodecane emulsion prepared with 1 mM peptide
SEQ ID NO: 1 pH 9.

| Chlorhexidine digluconate (mM) | Oil recovery (%) |
|---|---|
| 0.4 | 3 |
| 0.9 | 9 |
| 2.2 | 26 |
| 4.3 | 54 |
| 8.5 | 90 |
| 12.5 | 83 |
| 20.0 | 86 |
| 36.7 | 77 |

TABLE 17
Oil recovery after addition of chlorhexidine digluconate to a
50% dodecane emulsion containing 1 mM peptide
SEQ ID NO: 1 pH 7.

| Chlorhexidine digluconate (mM) | Oil recovery (%) |
|---|---|
| 0.9 | 16 |
| 2.2 | 45 |
| 3.5 | 58 |
| 4.3 | 86 |
| 6.4 | 95 |
| 8.5 | 89 |
| 12.5 | 91 |

### Example 7

### Controlled Coalescence of an Emulsion Prepared with 1 mM Peptide SEQ ID NO:8 pH 9. Effects of Chlorhexidine Digluconate, Borate Ion and Cationic Polyelectrolytes

An emulsion was prepared by sonication of equal volumes (12 mL) of 1 mM aqueous SEQ ID NO:8 pH 9.0 and hexadecane. The emulsion was subjected to controlled coalescence-studies by the addition of chlorhexidine digluconate (20% aqueous solution, ca. 0.22 M) to a desired final concentration in the aqueous phase. Oil recoveries after 5 minutes are given in Table 18. No oil was recovered on addition of 200 mM guanidinium chloride, showing that a bis-biguanide (chlorhexidine) can be a more effective demulsifier than guanidinium.

To a portion of the remaining emulsion, 10 mM K⁺borate pH 9 was added from a 2 M stock, and emulsion breaking studies were repeated. Results are given in Table 19, and show that borate ion, which is a co-ion, acts as a stoichiometric inhibitor of chlorhexidine in the coalescence of SEQ ID NO:8 emulsions, presumably by binding to and/or precipitating chlorhexidine.

TABLE 18
Oil recovery after addition of chlorhexidine digluconate to a
50% hexadecane emulsion prepared with 1 mM
SEQ ID NO: 8 pH 9.

| Chlorhexidine digluconate (mM) | Oil recovery (%) |
|---|---|
| 2.2 | 9 |
| 4.3 | 19 |
| 6.4 | 85 |
| 8.5 | 83 |
| 10.5 | 67 |
| 12.5 | 70 |

TABLE 19
Oil recovery after addition of chlorhexidine digluconate to a 50%
hexadecane emulsion containing 1 mM SEQ ID NO: 8,
10 mM K⁺ borate, pH 9.

| Chlorhexidine digluconate (mM) | Oil recovery (%) |
|---|---|
| 4.3 | 7 |
| 8.5 | 13 |
| 12.5 | 74 |
| 16.3 | 76 |
| 20.0 | 84 |
| 23.6 | 84 |
| 27.0 | 90 |

### Example 8

### Controlled Coalescence of an Emulsion of Crude Biodiesel with Water. Effects of poly(hexamethylene biguanide) Hydrochloride (PHMB)

A sample of crude biodiesel, generated by anhydrous reaction of plant oil with methanol in the presence of potassium hydroxide catalyst, was obtained from a commercial producer. The resulting fatty acid methyl esters and other oil-soluble components were first separated from the glycerol phase of the reaction by gravity-assisted drainage. To a 10 mL sample of the crude biodiesel was added 0.5 mL of either (i) water, (ii) 5% (w/v) anhydrous sodium sulfate solution, or (iii) 40% (w/v) PHMB solution. The oil and aqueous phases were shaken together by hand to form a coarse emulsion, then subjected to heating at 90-° C. to facilitate phase separation. After 30 min heating, biodiesel shaken with either water or sodium sulfate solution showed a diffuse cloudy interface not conducive to clean separation of the oil and aqueous phases. In contrast, biodiesel shaken with PHMB solution showed separation of three liquid phases with sharp interfaces conducive to clean separation. The most dense phase was a clear colourless phase (ca. 0.3 mL), overlaid by a dark brown phase (ca. 0.2 mL), with the biodiesel phase above these phases. When the lower two phases were removed and the biodiesel phase was shaken with a further 0.5 mL water, followed by heating at 90° C. for 30 min, a clear aqueous phase with a sharp interface was observed, indicating that the biodiesel had been successfully separated from endogenous emulsifying components, such as fatty acid soaps. Further heating of biodiesel treated with either water, or sodium sulfate solution alone during the same time period did not give rise to clean separation of the biodiesel and aqueous phases. The results show that PHMB, as a polymeric chaotropic counterion, is effective in breaking emulsions formed with complex mixtures of natural emulsifiers.

### Example 9

### Controlled Coalescence of an Emulsion Prepared with 5 mM Cetylpyridinium Chloride. Effects of Different Sodium Salts

An emulsion was prepared by sonication of equal volumes (10 mL) of 5 mM aqueous cetylpyridinium chloride and ca. 100 μM Sudan III in tetradecane. The emulsion was subjected to controlled coalescence studies by the addition of different sodium salts to give a desired final concentration in the aqueous phase. Oil recoveries after 5 minutes are given in Tables 20 to 25. The results show that chaotropic counterions are effective in breaking emulsions prepared with cationic surfactants. The results also show that for a surfactant containing a strongly chaotropic headgroup (alkylpyridinium cation), relatively weak chaotropes are adequate to induce coalescence. For some chaotropes, an optimum concentration for coalescence is observed. For the very strong chaotropic anion hydrosulfate, coalescence begins to occur at molar ratios close to 1:1.

Oil recovery (%) obtained with specific cations at specific concentrations are given in Tables 20 to 25.

TABLE 20
Oil recovery after addition of sodium chloride to a 50% tetradecane
emulsion prepared with 5 mM cetylpyridinium chloride.

| Sodium chloride (mM) | Oil recovery (%) |
|---|---|
| 50 | 0 |
| 100 | 0 |
| 150 | 18 |
| 200 | 33 |
| 250 | 55 |

TABLE 21
Oil recovery after addition of sodium nitrate to a 50% tetradecane
emulsion prepared with 5 mM cetylpyridinium chloride.

| Sodium nitrate (mM) | Oil recovery (%) |
|---|---|
| 50 | 0 |
| 100 | 51 |
| 150 | 0 |
| 200 | 0 |
| 250 | 0 |

TABLE 22
Oil recovery after addition of sodium iodide to a 50% tetradecane
emulsion prepared with 5 mM cetylpyridinium chloride.

| Sodium iodide (mM) | Oil recovery (%) |
|---|---|
| 50 | 37 |
| 100 | 79 |
| 150 | 79 |
| 200 | 84 |
| 250 | 87 |

TABLE 23
Oil recovery after addition of sodium thiocyanate to a 50% tetradecane
emulsion prepared with 5 mM cetylpyridinium chloride.

| Sodium thiocyanate (mM) | Oil recovery (%) |
|---|---|
| 50 | 0 |
| 100 | 75 |
| 150 | 57 |
| 200 | 44 |
| 250 | 43 |

TABLE 24
Oil recovery after addition of sodium perchlorate to a 50% tetradecane
emulsion prepared with 5 mM cetylpyridinium chloride.

| Sodium perchlorate (mM) | Oil recovery (%) |
|---|---|
| 50 | 66 |
| 100 | 59 |
| 150 | 68 |
| 200 | 57 |
| 250 | 54 |

TABLE 25
Oil recovery after addition of sodium hydrosulfate to a 50% tetradecane
emulsion prepared with 5 mM cetylpyridinium chloride.

| Sodium hydrosulfate (mM) | Oil recovery (%) |
|---|---|
| 10 | 7 (58)* |
| 20 | 52 (76)* |
| 30 | 57 (73)* |
| 40 | 13 (52)* |

*FIGURES in brackets indicate total oil recovery after 18 h.

### Example 10

### Controlled Coalescence of an Emulsion Prepared with 5 mM Stearylammonium Acetate. Effects of Different Sodium Salts

An emulsion was prepared by sonication of equal volumes (10 mL) of 5 mM aqueous stearylammonium acetate and ca. 100 μM Sudan III in hexadecane. The emulsion was subjected to controlled coalescence studies by the addition of different sodium salts to give a desired final concentration in the aqueous phase. Oil recoveries after 5 minutes are given in Tables 26 to 29. The results show that chaotropic counterions are effective in breaking emulsions prepared with cationic surfactants. The results also show that for a surfactant containing a weakly chaotropic headgroup (monoalkylammonium cation), relatively strong chaotropes are required to induce coalescence.

Oil recovery (%) obtained with specific cations at specific concentrations are given in Tables 26 to 29.

TABLE 26
Oil recovery after addition of different sodium salts to a 50% hexadecane
emulsion prepared with 5 mM stearylammonium acetate.

| Salt | Oil recovery (%) |
|---|---|
| Sodium chloride (50-250 mM) | 0 |
| Sodium iodide (50-250 mM) | 0 |
| Sodium thiocyanate (50-250 mM) | 0 |

TABLE 27
Oil recovery after addition of sodium perchlorate to a 50% hexadecane
emulsion prepared with 5 mM stearylammonium acetate.

| Sodium perchlorate (mM) | Oil recovery (%) |
|---|---|
| 50-250 | 0 |
| 500 | 75 |

TABLE 28
Oil recovery after addition of sodium methyl sulfate to a 50% hexadecane
emulsion prepared with 5 mM stearylammonium acetate.

| Sodium methyl sulfate (mM) | Oil recovery (%) |
|---|---|
| 50 | 24 |
| 100 | 49 |
| 150 | 66 |
| 200 | 76 |
| 250 | 83 |
| 500 | 87 |

TABLE 29
Oil recovery after addition of sodium hydrosulfate to a 50% hexadecane
emulsion prepared with 5 mM stearylammonium acetate.

| Sodium hydrosulfate (mM) | Oil recovery (%) |
|---|---|
| 50 | 87 |
| 100 | 83 |
| 150 | 90 |
| 200 | 83 |
| 250 | 87 |
| 500 | 86 |

### Example 11

### Controlled Coalescence of an Emulsion Prepared with 5 mM Potassium Cetyl Phosphate. Effects of Different Chloride Salts

An emulsion was prepared by sonication of equal volumes (10 mL) of 5 mM aqueous potassium cetyl phosphate and ca. 100 μM Sudan III in tetradecane. The emulsion was subjected to controlled coalescence studies by the addition of different chloride salts to give a desired final concentration in the aqueous phase. Oil recoveries after 5 minutes are given in Tables 30 to 33. The results show that chaotropic counterions are effective in breaking emulsions prepared with a phosphate-based anionic surfactant. The results also show that for a surfactant containing a moderately kosmotropic headgroup (alkyl phosphate), relatively strong chaotropes and/or high salt concentrations are required to induce emulsion coalescence, although coalescence is still more facile than with fatty acid emulsions. The results also show that while a polymer containing a moderately chaotropic functional group (tetraalkylammonium group, poly(dimethyldiallylammonium chloride)) is ineffective at breaking an emulsion containing a phosphate-based surfactant, more effective emulsion breaking can be achieved using a polymer containing a strongly chaotropic functional group (biguanide group, poly(hexamethylene biguanide)).

Oil recovery (%) obtained with specific cations at specific concentrations are given in Tables 30 to 33.

TABLE 30
Oil recovery after addition of sodium chloride to a 50% tetradecane
emulsion prepared with 5 mM potassium cetyl phosphate.

| Sodium chloride (mM) | Oil recovery (%) |
|---|---|
| 50 | 0 |
| 100 | 0 |
| 150 | 0 |
| 200 | 0 |
| 250 | 0 |
| 375 | 28 |
| 500 | 35 |

TABLE 31
Oil recovery after addition of guanidinium chloride to a 50% tetradecane
emulsion prepared with 5 mM potassium cetyl phosphate.

| Guanidinium chloride (mM) | Oil recovery (%) |
|---|---|
| 50 | 0 |
| 100 | 0 |
| 150 | 1 |
| 200 | 12 |
| 250 | 30 |
| 375 | 71 |
| 500 | 84 |

TABLE 32
Oil recovery after addition of poly(dimethyldiallylammonium chloride)
(pDMDAAC) to a 50% tetradecane emulsion prepared with 5 mM
potassium cetyl phosphate.

| pDMDAAC (mM) | Oil recovery (%) |
|---|---|
| 5 | 0 |
| 10 | 0 |
| 15 | 0 |
| 20 | 0 |
| 25 | 0 |

TABLE 33
Oil recovery after addition of poly(hexamethylene biguanide) (PHMB)
to a 50% tetradecane emulsion prepared with 5 mM potassium
cetyl phosphate.

| PHMB (mM) | Oil recovery (%) |
|---|---|
| 4 | 40 |
| 5 | 45 |
| 6 | 49 |
| 7.5 | 46 |
| 10 | 45 |
| 12 | 49 |
| 15 | 46 |
| 20 | 46 |
| 30 | 46 |
| 40 | 41 |
| 50 | 40 |

### REFERENCES

Aroti, A., Leontidis, E., Maltseva, E. and Brezesinski, G. 2004. Effects of Hofmeister anions on DPPC Langmuir monolayers at the air-water interface. J. Phys. Chem. B 108, 15238-15245.
Binks, B. P. 1998. Modern Aspects of Emulsion Science. Cambridge, Royal Society of Chemistry.
Broering, J. M. and Bommarius, A. S. 2005. Evaluation of Hofmeister effects on the kinetic stability of proteins. J. Phys. Chem. B 109, 20612-20619.
Cacace, M. G., Landau, E. M. and Ramsden, J. J. 1997. The Hofmeister series: salt and solvent effects on interfacial phenomena. Q. Rev. Biophys. 30, 241-277.
Collins, K. D. 2004. Ions from the Hofmeister series and osmolytes: effects on proteins in solution and in the crystallization process. Methods 34, 300-311.
Collins, K. D. and Washabaugh, M. W. 1985. The Hofmeister effect and the behavior of water at interfaces. Q. Rev. Biophys. 18, 323-422.
Dempsey, C. E., Mason, P. E., Bracly, J. W. and Neilson, G. W. 2007. The reversal by sulfate of the denaturant activity of guanidinium. J. Am. Chem. Soc. 129, 15895-15902.
East, G. C., McIntyre, J. E., Shao, J., 1997, Polymer, 38(15), 3973-3984.
Marcus, Y. 1986. The Hydration Entropies of Ions and Their Effects on the Structure of Water. Journal of the Chemical Society-Faraday Transactions I 82, 233-242.
Marcus, Y. 1987. The Thermodynamics of Solvation of Ions 0.2. the Enthalpy of Hydration at 298.15-K. Journal of the Chemical Society-Faraday Transactions 183, 339-349.
Marcus, Y. 1991. Thermodynamics of Solvation of Ions 0.5. Gibbs Free-Energy of Hydration at 298.15-K. Journal of the Chemical Society-Faraday Transactions 87, 2995-2999.
Nucci, N. V. and Vanderkooi, J. M. 2008. Effects of salts of the Hofmeister series on the hydrogen bond network of water. J. Mol. Liq. 143, 160-170.
Para, G. and Warszynski P., 2007, Cationic surfactant adsorption in the presence of divalent ions. Collord Surf. A, 300, 346-352.
Pegram, L. M. and Record, M. T. 2008a. Quantifying accumulation or exclusion of H+, HO−, and Hofmeister salt ions near interfaces. Chem. Phys. Lett. 467, 1-8.
Pegram, L. M. and Record, M. T. 2008b. Thermodynamic origin of Hofmeister ion effects. J. Phys. Chem. B 112, 9428-9436.
Sedlak, E., Stagg, L. and Wittung-Stafshede, P. 2008. Effect of Hofmeister ions on protein thermal stability: Roles of ion hydration and peptide groups? Arch. Biochem. Biophys. 479, 69-73.
Zhang, S. J., Sun, N., He, X. Z., Lu, X. M. and Zhang, X. P. 2006. Physical properties of ionic liquids: Database and evaluation. J. Phys. Chem. Ref. Data 35, 1475-1517.
Zhang, Y. J. and Cremer, P. S. 2006. Interactions between macromolecules and ions: the Hofmeister series. Curr. Opin. Chem. Biol. 10, 658-663.

1. A method of controlling coalescence and/or phase separation of an emulsion stabilized by an ionic surfactant comprising adding to the emulsion a chaotropic counterion.

2. The method according to claim 1 wherein the ionic surfactant is an anionic surfactant.

3. The method according to claim 1 wherein the ionic surfactant is a cationic surfactant.

4. The method according to claim 1 wherein the ionic surfactant is zwitterionic.

5. The method according to claim 1 wherein the counterion is a singly-charged counterion.

6. The method according to claim 1 wherein the counterion is a polyelectrolyte.

7. The method according to claim 1 wherein controlling is promoting.

8. The method according to claim 5 wherein the counterion is selected from guanidinium, imidazolium, iodide, thiocyanate, perchlorate and hydrosulfate.

9. The method according to claim 6 wherein the counterion is selected from a polyguanidine, biguanide, polybiguanide, polysulfate, polysulfonate, polyphosphate or polyphosphonate.

10. The method according to claim 9 wherein the counterion is the polyelectrolyte chlorhexidine or polyhexamethylene biguanide.

11. The method according to claim 1 wherein the ionic surfactant has at least one strongly hydrated ionic group.

12. The method according to claim 11 wherein the at least one strongly hydrated ionic group is a carboxylate ion.

13. The method according to claim 11 wherein the chaotropic counterion is a polyelectrolyte.

14. The method according to claim 13 wherein the polyelectrolyte is a bis(biguanide) or polybiguanide.

15. The method according to claim 14 wherein the bis(biguanide) is chlorhexidine.

16. The method according to claim 14 wherein the polybiguanide is polyhexamethylene biguanide.
